(19) United States
(12) Patent Application Publication
(10) Pub. No.: US 2008/0022004 A1
(43) Pub. Date: Jan. 24, 2008

(54) Method And System For Providing Resources By Using Virtual Path

(75) Inventors: Seung Hyun Kim, Daegu-city (KR); Yeong Sub Cho, Daejeon-city (KR); Jong Hyouk Noh, Daejeon-city (KR); Sang Rae Cho, Daejeon-city (KR); Dae Seon Choi, Daejeon-city (KR); Tae Sung Kim, Daejeon-city (KR); Seung Hun Jin, Daejeon-city (KR)

Correspondence Address: LAHIVE & COCKFIELD, LLP, ONE POST OFFICE SQUARE, BOSTON, MA, 02109-2127, US

(73) Assignee: Electronics and Telecommunications Research Institute, Daejeon (KR)

(21) Appl. No.: 11/792,323

(22) PCT Filed: Nov. 28, 2005
(86) PCT No.: PCT/KR05/04013

§ 371 Date: Jun. 4, 2007

(30) Foreign Application Priority Data
Dec. 4, 2004 (KR) 10-2004-0101475
Jun. 21, 2005 (KR) 10-2005-0053560

(51) Int. Cl. G06F 15/16

(52) U.S. Cl. 709/229

(57) ABSTRACT

A method and system for providing resources by using a virtual path are provided. The method includes: extracting comparison client information corresponding to a virtual path policy from a client that wants to access a resource server and has logged in through a virtual path that is generated so that the resource server is accessed through a virtual path server; comparing the comparison client information with original client information that is already stored in the virtual path server; and if the verification is successful, providing resources to the client that wants to access the resource server through the virtual path. Accordingly, without a separate login verification procedure, basic security can be supported only with the virtual path. Also, according to a security policy, a flexible login verification procedure can be enabled, and misuse and abuse, such as illegal linking to resources, can be properly handled.

### TECHNICAL FIELD

The present invention relates to a resource providing method and system using a virtual path, and more particularly, to a resource providing method and system using a virtual path, by which the virtual path can be generated in a variety of environments and used as an element for confirming a login of a client. The present invention relates to a resource providing method and system using a virtual path, and more particularly, to a resource providing method and system using a virtual path, by which the virtual path can be generated in a variety of environments and used as an element for confirming a login of a client.

### BACKGROUND ART

In wired and wireless environments including the Internet, numerous resources are being provided to people around the world. However, resources are exposed to clients without protection, and accordingly the resources can be misused and abused.

Accordingly, many systems on the Internet being operated based on membership systems prepare their respective login procedures such that only the clients that pass the login procedure can access resources. That is, conventionally, a method by which a login procedure is performed whenever a resource is accessed, or a method by which previous login information is inquired and access is permitted is mainly used.

However, this access method has a problem in that the process to check an access to a resource puts a load onto the system, and for a resource that is not so important, this process is too complicated and takes a lot of time.

Korean Patent Application No. 10-2000-0050891, ‘A client login system using a second access path,’ discloses a system which classifies access paths into two types, a first access path and a second access path, and in a case of an abnormal process, requests an additional login. However, the client system using a second access path like this causes inconvenience in that it requires additional processing, and also requires logic to distinguish normal and abnormal processes.

Also, Korean Patent Application No. 10-2004-0029571, ‘A method of displaying a multimedia file’, discloses a method of cutting off illegal link and download problems caused by exposure of a uniform resources locator (URL) and at the same time preventing a phenomenon that a web server is overloaded.

### DISCLOSURE OF INVENTION

### Technical Problem

According to this method, when a URL for a multimedia file is requested, a user login procedure through a login program should be followed, and then, the URL can be accessed. By doing so, the illegal link and illegal download problems caused by the exposure of the URL of the multimedia file inside the source can be blocked. However, this multimedia file display method prevents only public exposure of the URL of the multimedia file to the client, and at the time when the file is used, the URL of the multimedia file is used such that the actual URL can be exposed by an illegal method.

### Technical Solution

The present invention provides a resource providing method and system using a virtual path, the method and system capable of reducing additional loads due to confirmation of login information and at the same time preventing misuse and abuse of resources, by generating and using a unique virtual path for each client.

### Advantageous Effects

The present invention can provide system security and system reliability of clients through a method and system of generating and using a unique virtual path to address the problem of misuse and abuse of client's rights, such as illegal linking or downloading resources.

Also, through the present invention, the load of performing a login procedure through a virtual path server whenever a resource server is accessed after a client logs in to the virtual path server through a virtual path can be reduced.

### DESCRIPTION OF DRAWING

FIG. 1 is a block diagram of a resource providing system using a virtual path according to an embodiment of the present invention;

FIG. 2 is a flowchart of a method for receiving a virtual path from a resource providing system using a virtual path according to an embodiment of the present invention; and

FIG. 3 is a flowchart of a method of verifying a virtual path in a resource providing system using a virtual path, and receiving resources from the resource providing system according to an embodiment of the present invention.

### BEST MODE

According to an aspect of the present invention, there is provided a resource providing method for providing resources to a client which logs in to a virtual path server, using a virtual path, the method including: generating a virtual path allowing access to a resource server, and transmitting the virtual path to the logged in client; extracting from the logged in client, original client information corresponding to a virtual path policy for verification of access to the resource server, and mapping and storing the original client information and the virtual path information; and extracting comparison client information corresponding to the virtual path policy from the client requesting resources of the resource server through the virtual path, and if the comparison client information is compared with the original client information and the verification is successful, allowing the resources to be provided through the virtual path.

According to another aspect of the present invention, there is provided a method of providing resources to a client which logs in to a virtual path server, using a virtual path, the method including: generating a virtual path allowing access to a resource server and transmitting the virtual path to the logged in client; receiving a request of resources of the resource server, from the logged in client through the virtual path; and allowing the resources of the resource server to be provided to the logged in client through the virtual path.

According to still another aspect of the present invention, there is provided a resource providing system for providing resources to a client which logs in to a virtual path server, using a virtual path, the system including: a virtual path generation and transmission unit generating a virtual path allowing access to a resource server, and transmitting the virtual path; a storage unit extracting from the logged in client, original client information corresponding to a virtual path policy for verification of access to the resource server, and mapping and storing the original client information and the virtual path information; and a virtual path verification unit extracting comparison client information corresponding to the virtual path policy from the client requesting resources through the virtual path, and if the comparison client information is compared with the original client information loaded from the storage unit and the verification is successful, allowing the resources to be provided through the virtual path.

### Mode for Invention

The present invention will now be described more fully with reference to the accompanying drawings, in which exemplary embodiments of the invention are shown.

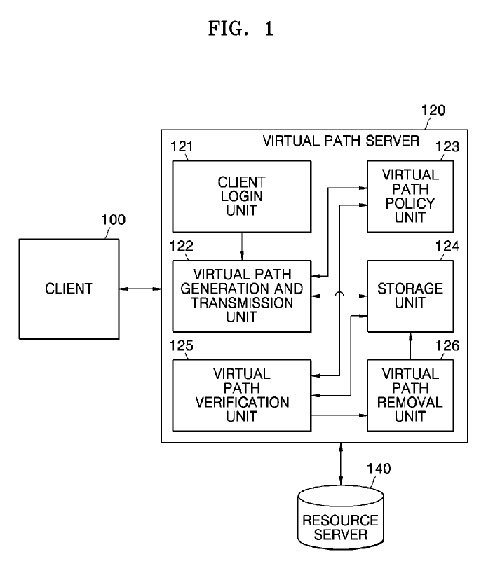

FIG. 1 is a block diagram of a resource providing system using a virtual path according to an embodiment of the present invention. Referring to FIG. 1, the resource providing system using a virtual path according to the current embodiment of the present invention includes a client 100, a virtual path server 120 and a resource server 140. The client 100 is an apparatus which accesses the Internet and by using software, accesses the virtual path server 120. Examples of the client 100 that are currently widely used include a personal computer and a mobile terminal.

The virtual path server 120 includes a client login unit 121, a virtual path generation and transmission unit 122, a virtual path policy unit 123, a storage unit 124, a virtual path verification unit 125, and virtual path removal unit 126.

The client login unit 121 receives inputs of login information, including an ID and a password, from the client 100, and determines whether or not the client 100 that wants to log in to the virtual path server 120 is authenticated. If it is determined that the login of the client 100 accessing the virtual path server 120 is authenticated, the client login unit 121 transmits a login authentication confirmation signal to the virtual path generation and transmission unit 122.

If the login authentication confirmation signal from the client login unit 121 is received, the virtual path generation and transmission unit 122 generates a virtual path enabling the client 100 whose login is authenticated, to access the resource server 140, and transmits the generated virtual path to the client 100 whose login is authenticated. Here, a virtual path transmitted to each client 100 is a unique virtual path. Whether or not a virtual path is unique is determined by checking whether or not there is a virtual path identical to the transmitted virtual path, among previously generated virtual paths. Furthermore, the unique virtual path can be safely transmitted to the client 100 by additional security technology. After receiving the virtual path, the client 100 can access the resource server 140 without providing separate login information to the virtual path server 120 every time.

In the virtual path policy unit 123, a virtual path policy which defines a comparison factor to verify that the client 100 can access the resource server 140 through a virtual path, is set. Here, IP information of a client, session login time information of a client, and session login method information of a client can be included as comparison factors and used. Also, verification of an item defined as a virtual path policy that is a comparison factor, is performed by comparing original client information extracted from the client 100 in a process for performing a login, with comparison information extracted from the client that wants to actually access the resource server 140 through a virtual path.

The storage unit 124 extracts from the logged in client 100, original client information corresponding to the client 100 according to the virtual path policy set in the virtual path policy unit 123, and maps and stores the original client information and virtual path information.

The virtual path verification unit 125 extracts from the client 100 accessing the resource server 140 through a virtual path, comparison client information corresponding to the client 100 according to the virtual path policy already set in the virtual path policy unit 123, and loads the original client information stored in the storage unit 124.

Then, the virtual path verification unit 125 compares the extracted comparison client information with the loaded original client information, and determines whether or not the verification is successful. If the verification performed in the virtual path verification unit 125 is successful, the client that wants to access the resource server 140 through the virtual path is given a permission.

If the verification in the virtual path verification unit 125 is not successful, the virtual path removal unit 126 receives an input of a verification failure message from the virtual path verification unit 125 and removes the virtual path information stored in the storage unit 124.

The resource server 140 is positioned at a location which the client 100 cannot access directly, and only through a virtual path provided after the client logs in to the virtual path server 120, can the client 100 access the resource server 140. Here, the resource server 140 includes a variety of resources and provides numerous resources on wired and wireless environments, including the Internet.

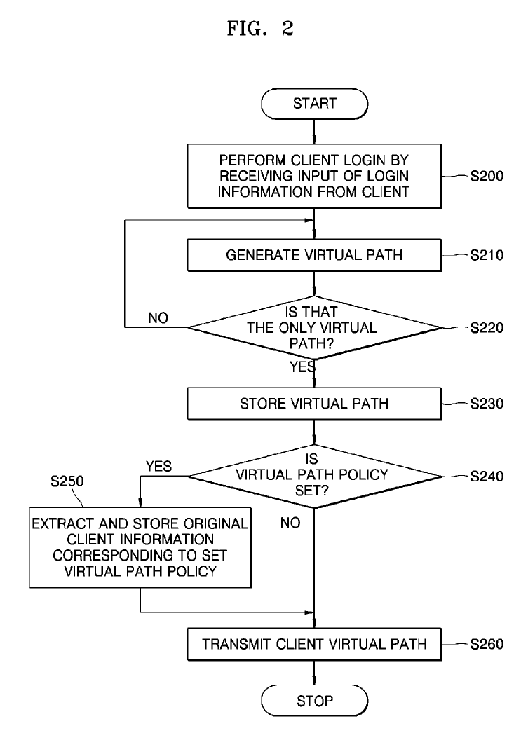

FIG. 2 is a flowchart of a method of receiving a virtual path from a resource providing system using a virtual path according to an embodiment of the present invention. Referring to FIG. 2, first, the virtual path server 120 receives inputs of login information from the client 100, including an ID and password, and performs a login procedure of the client 100 in operation S200. Here, though the login of the client 100 performed based on the ID and password is shown, a variety of methods, including a login procedure based on a public certificate, can be used.

Next, if the login of the client 100 is performed in operation S200, the virtual path server 120 generates a virtual path enabling the logged in client 100 to access the resource server 140 in operation S210.

Then, the virtual path server 120 determines whether or not the virtual path generated in the operation S210 is a unique path in operation S220. Here, the determining of whether or not the path is unique is performed by determining whether or not there is a virtual path identical to the virtual path generated in operation S210, among virtual paths generated previously in the virtual path server 120. The reason for determining whether or not the virtual path is a unique path in operation S220 is to allow only the client 100 that logged in operation S200, to access the resource server 140 through the virtual path.

If the determination result of the operation S220 indicates that the virtual path is not a unique path, operation S210 is performed again. Meanwhile, if the determination result of operation S220 indicates that the virtual path is a unique path, operation S230 is performed.

In operation S230, the virtual path generated in operation S210 is stored. Here, the virtual path is stored in the storage unit 124 of the virtual path server 120.

Next, the virtual path server 120 determines whether or not a virtual path policy is set in operation S240. This is performed by determining whether or not there is a previously set virtual path policy in the virtual path policy unit 123 of the virtual path server 120.

Here, the virtual path policy means a policy that sets a comparison factor to determine whether or not, when the client 100 wants to access the resource server 140 through a virtual path provided by the virtual path server 120, the client 100 is an authorized client 100 that receives a virtual path after performing a login procedure.

Determining whether or not a virtual path policy is set is to determine whether or not there is a comparison factor previously set in the virtual path policy unit 123. More specifically, examples of the comparison factor include client session effective time information, client session login method information, and client IP information.

If the determination result of operation S240 indicates that there is a set virtual path policy, original client information corresponding to the virtual path policy is extracted from the logged in client 100 and stored in operation S250. Here, the original client information corresponding to the virtual path policy is the client information that is extracted because it corresponds to the set virtual path policy according to the determination result in operation S240. Also, when the original client information is stored in operation S250, the original client information can be stored after a matching process with the virtual path information stored in operation S230.

Meanwhile, if the determination result of the operation S240 indicates that there is no set virtual path policy, the virtual path generated in operation S210 is provided to the logged in client 100 in operation S260. Also, after operation S250, operation S260 is performed such that the virtual path generated in operation S210 is provided to the logged in client 100.

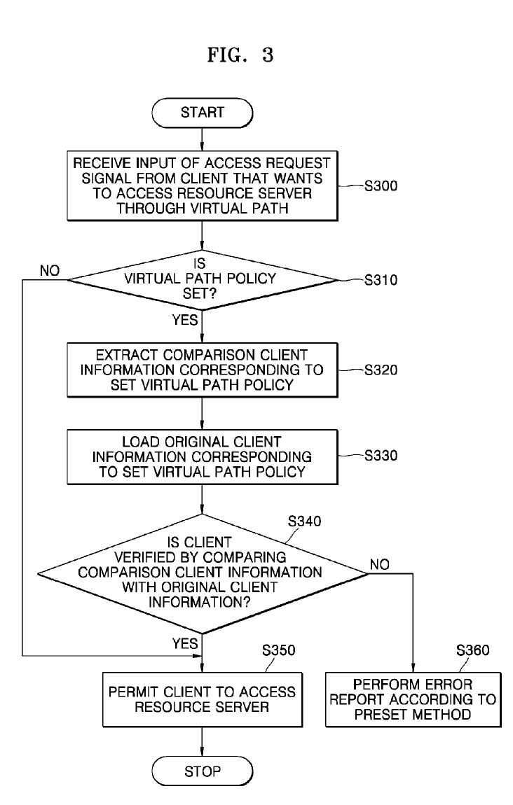

After operation S260, the logged in client 100 which receives the virtual path can access the resource server 140 by performing a following procedure illustrated in FIG. 3, and can receive desired resources. Hereinafter, the method of accessing the resource server 140 and receiving desired resources will be explained in more detail. For those parts that are not explained in FIG. 2, FIG. 1 will be referred to.

FIG. 3 is a flowchart of a method of verifying a virtual path in a resource providing system using a virtual path, and receiving resources from the resource providing system according to an embodiment of the present invention.

Referring to FIG. 3, first, the virtual path server 120 receives an input of an access request signal from the client 100 that wants to access the resource server 140 through a virtual path in operation S300.

Next, if the access request signal is input in operation S300, it is determined whether or not there is a set virtual path policy in operation S310. Here, the determining of whether or not there is a set virtual path policy is performed by determining whether or not there is a virtual path policy previously set in the virtual path policy unit 123 of the virtual path server 120.

In order to determine whether or not there is a virtual path policy in the virtual path policy unit 123, the virtual path verification unit 125 loads the virtual path policy unit 123.

If the determination result of the operation S310 indicates that there is not a set virtual path policy, operation S350 is performed. Meanwhile, if the determination result of operation S310 indicates that there is a set virtual path policy, operation S320 is performed.

In operation S320, according to the virtual path policy set in the virtual path server 120, comparison client information is extracted from the client 100 which transmitted the access request signal in operation S300.

In operation S330, original client information identical to the virtual path policy determined in operation S310 is loaded. Here, the original client information is stored in the storage unit 124 of the virtual path server 120, and for more details of the original client information, FIG. 2 can be referred to.

After operation S330, the virtual path server 120 determines whether or not the client 100 which transmitted the access request signal to the resource server 140 is an authorized client in operation S340. Here, whether or not the client 100 is an authorized client is verified by determining whether or not the comparison client information extracted in operation S320 is identical to the original client information loaded in operation S330. That is, if the comparison client information is identical to the original client information, it is determined that the client 100 is an authorized client, and if not, it is determined that the client 100 is not an authorized client. More specifically, examples of the client information used as the comparison factor include a client session effective time, a client session login method, and a client IP.

If the determination result of operation S340 indicates that the client 100 is an authorized client, operation S350 is performed. Meanwhile, if the determination result of operation S340 indicates that the client 100 is not an authorized client, operation S360 is performed.

In operation S350, the client 100 that wants to access the resource server 140 through a virtual path is permitted to access the resource server 140. By doing so, the client 100 is able to receive resources existing in the resource server 140. In operation S360, an error report to the client 100 that wants to access the resource server 140 through a virtual path is performed according to a previously set method.

More specifically, if the client information used as the comparison factor is the IP information of the client 100 in the previously set method, a message indicating that the IP information of the user should be reconfirmed because the IP information is not identical can be transmitted. Also, if the client information used as the comparison factor is the session authentication time information of the client 100, a message indicating that a login should be performed again because the authenticated time has expired can be transmitted. For those parts that are not explained with reference to FIG. 3, FIGS. 1 and 2 can be referred to.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

The present invention can provide system security and system reliability of clients through a method and system of generating and using a unique virtual path to address.

1. A resource providing method for providing resources to a client which logs in to a virtual path server, using a virtual path, the method comprising:
generating a virtual path allowing access to a resource server, and transmitting the virtual path to the logged in client;
extracting from the logged in client, original client information corresponding to a virtual path policy for verification of an access to the resource server, and mapping and storing the original client information and the virtual path information; and
extracting comparison client information corresponding to the virtual path policy from the client requesting resources of the resource server through the virtual path, and if the comparison client information is compared with the original client information and the verification is successful, allowing the resources to be provided through the virtual path.

2. The method of claim 1, wherein the extraction of the comparison client information and allowing of the resources comprises:
receiving an access request signal from the client that requests the resources of the resource server through the virtual path;
extracting the comparison client information corresponding to the virtual path policy from the client that requests the resources of the resource server;
loading the mapped and stored original client information;
comparing the extracted comparison client information with the original client information to determine whether or not the verification is successful;
if it is determined that the verification is successful, allowing the resources to be provided to the client requesting the resources of the resource server through the virtual path.

3. The method of claim 2, further comprising, if the determination result indicates that the verification is unsuccessful, sending an error report to the client requesting the resources of the resource sever according to a previously set method.

4. The method of claim 2, further comprising, if the determination result indicates that the verification is unsuccessful, removing the virtual path.

5. The method of claim 1, wherein the client information extracted according to the virtual path policy is session login time information of the client.

6. The method of claim 1, wherein the client information extracted according to the virtual path policy is Internet protocol (IP) information of the client.

7. The method of claim 1, wherein the virtual path is a unique virtual path through which only the client receiving the virtual path accesses the resource server.

8. A method of providing resources to a client which logs in to a virtual path server, using a virtual path, the method comprising:
generating a virtual path allowing access to a resource server and transmitting the virtual path to the logged in client;
receiving a request of the resources of the resource server from the logged in client through the virtual path; and
allowing the resources of the resource server to be provided to the logged in client through the virtual path.

9. The method of claim 8, wherein the virtual path is a unique virtual path through which only the client receiving the virtual path can access the resource server.

10. A resource providing system for providing resources to a client which logs in to a virtual path server, using a virtual path, the system comprising:
a virtual path generation and transmission unit generating a virtual path allowing access to a resource server, and transmitting the virtual path;
a storage unit extracting from the logged in client, original client information corresponding to a virtual path policy for verification of access to the resource server, and mapping and storing the original client information and the virtual path information; and
a virtual path verification unit extracting comparison client information corresponding to the virtual path policy from the client requesting resources through the virtual path, and if the comparison client information is compared with the original client information loaded from the storage unit and the verification is successful, allowing the resources to be provided through the virtual path.

11. The system of claim 10, wherein the client information extracted according to the virtual path policy is session login time information of the client.

12. The system of claim 10, wherein the client information extracted according to the virtual path policy is Internet protocol (IP) information of the client.

13. The system of claim 10, further comprising a virtual path policy unit in which the virtual path policy is set.

14. The system of claim 10, further comprising a virtual path removal unit receiving a verification failure message from the virtual path verification unit if the verification in the virtual path verification unit is unsuccessful, and removing the virtual path information stored in the storage unit.

15. The system of claim 10, further comprising a virtual path removal unit receiving an input of a logout signal if the logged in client logs out, and removing the virtual path information stored in the storage unit.

16. The system of claim 10, wherein the virtual path generated in the virtual path generation and transmission unit is a unique virtual path through which only the client receiving the virtual path can access the resource server.
